(19) United States
(12) Patent Application Publication
(10) Pub. No.: US 2009/0262948 A1
(43) Pub. Date: Oct. 22, 2009

(54) HEARING AID AND METHOD FOR OPERATING A HEARING AID

(75) Inventors: Ivo Hasler, Winterthur (CH); Felix Aebersold, Herrliberg (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/301,627

(22) PCT Filed: May 22, 2006
(86) PCT No.: PCT/EP06/62496

§ 371 Date: Jan. 26, 2009

(51) Int. Cl. H04R 29/00; H04R 25/00

(52) U.S. Cl. 381/60; 381/312

(57) ABSTRACT

The invention relates to a hearing aid comprising at least one signal processing device, at least one counter for detecting discreet events or operating processes, and at least one memory for storing the values or states of the counter, and the threshold values associated with each counter. The hearing aid is also provided with a signal transmitter that is actively connected to the signal processing device in such a way that the signal transmitter is activated when a threshold value of a counter is reached or exceeded. In this way, advantageously, any countable pre-defined events or operating processes can be used to establish and maintain the operating state of the hearing aid. An operating process can be, for example, the variation of a defined operating state of the hearing aid. If a predetermined threshold value is reached, i.e. the number of events reaches this threshold value, a corresponding signal can be triggered and produced by the signal transmitter.

This invention relates to a hearing aid with the characterizing features specified in claim 1, and to a method for operating a hearing aid as conceptually specified in claim 11.

Hearing aids have been in existence in numerous variations, often differentiated by such categories as behind-the-ear hearing aids, in-the-ear hearing aids, and implants.

Then there have been programmable hearing aids which allow basic settings and functions to be adapted, by appropriate adjustments or programming, to the individual preferences and requirements of the user. This is accomplished in the course of an adjustment phase during which, usually in multiple sessions with the audiologist (or hearing aid acoustician), the hearing aid is adjusted, i.e. adapted, to the user's needs.

The user is typically given a fully functional hearing aid in which, independent of the intended operational purpose such as the selection of a partial range of features, the entire gamut of functionalities is available.

DE 199 16 900 describes a digital hearing aid that uses a key for enabling and/or blocking functions, performance features or programmable settings. It can employ hardware keys as well as pure software keys. The selected functions can only be activated or locked out after the key has been entered. This, for example, allows the user to test certain functions which can then either be kept in a constantly enabled state, or deactivated. It is also proposed that, after activation, these functions be left enabled only for a particular, predefined length of time after which they would lock themselves out automatically. The primary purpose is to prevent the improper, incorrect or unauthorized use of the hearing aid.

For practical considerations, due to the associated space requirements, the use of hardware keys is limited to behind-the-ear hearing aids.

Software keys can be used even for highly miniaturized hearing aids especially of the digital type but make it necessary in each case to use a key that is specifically configured for the individualized hearing aid. Safekeeping and using a key of that type poses a significant challenge in terms of logistics as well as handling. For example, it is especially after extended maintenance intervals, or after a move to another residence, that problems can arise in connection with keys that have been lost, forgotten or are no longer available, requiring the replacement of at least the programming module when a function needs to be disabled or enabled.

DE 199 16 900 describes a hearing aid in which the activation or deactivation of a function is triggered by a meter. In this case, after a predefined length of time has elapsed, a certain action is triggered, for instance the activation or deactivation of another function. Time-based settings of that type, however, become highly restrictive especially during the adjustment phase and do not offer enough flexibility for accommodating a diversity of requirements.

EP 1 545 153 describes a programmable hearing aid that is equipped with a meter for any kind of definable actions, and an evaluation logic with preselectable i.e. preadjustable threshold values. Exceeding these threshold values will deactivate specific functions of the hearing aid, or even all functions so as to actually disable the hearing aid altogether. This, for one example, will prevent an operational hearing aid from going astray during the adjustment phase when the user typically has not made any payments yet, or has not paid in full. It is thus possible for the audiologist to control, i.e. to enable or disable, the operability of the entire hearing aid.

All of these earlier hearing aids, and methods for operating hearing aids, are designed to directly control the functionality of the hearing aid concerned, in that they are either time-controlled or event-controlled. The user is merely informed, or allowed the use, of the action.

It is the objective of this present invention to introduce a hearing aid which is capable, in simple fashion, of letting the user know when the device should be serviced or repaired.

Another objective of this invention is the introduction of a hearing aid that is capable of giving the service center or the manufacturer information with regard to the operating history of the device.

According to the invention, these objectives are achieved with a hearing aid offering the characterizing features specified in claim 1. Other, preferred design implementations are characterized by the features described in claims 2 to 10.

According to the invention, a hearing aid incorporating at least one signal processing unit, at least one meter for measuring discrete events or functional processes and at least one memory module for storing the respective meter count, status and assigned threshold values, is additionally equipped with a signaling device that is functionally connected with the signal processing unit in a manner whereby the signaling device is activated the moment a meter threshold is reached or exceeded.

This makes it possible in advantageous fashion to utilize any measurable predefined event or functional process for determining and securing the operating status of the hearing aid. One example of a functional process is the change of a particular operating status of the hearing aid. When a predefined threshold is reached, i.e. when the number of events reaches that limit, the signaling device will trigger or generate a corresponding signal.

This may be used for instance as a reminder for a scheduled inspection or maintenance service of the hearing aid without directly affecting the functionality of the hearing aid. What this means is that it will not necessarily restrict the functionality of the hearing aid.

For example, the signaling device may be directly integrated into the signal processing unit. In programmable hearing aids that function could be performed by the signal processing unit itself, which is already there. Of course, the use of a separate module is equally possible.

The signaling device generates for instance an acoustic signal. The wearer of the hearing aid will be immediately aware of the acoustic signal and able to respond to it.

An example of the acoustic signal thus generated could be a simple sound, a tune or a voice message. In its simplest form, the attainment of a threshold can be signaled by generating an acoustic sound such as a beep or an audio signal of a specific frequency and duration. Of course, it is equally possible to generate a particular sequence of sounds or even a specific tune to identify a certain event. In another variation, the event is indicated by a direct voice message that notifies the user of the hearing aid of the event in clear and unmistakable fashion.

A message of that type will be stored as a retrievable signal in the nonvolatile memory of the hearing aid and will be called up the moment the limit or threshold value is exceeded.

As another example, the signaling device can generate a visual signal, for instance by switching on an indicator lamp or light-emitting diode. Depending on the event detected, it may suffice for the visual indicator to be activated when the hearing aid is put down, without additionally generating any audio signals.

In another example, a wireless transmitter is provided that interacts with the signaling device or the signal processing unit in a manner whereby a wireless signal is generated the moment the threshold of a meter is reached or exceeded. A signal of that type will be transmitted for instance to the remote control of the hearing aid where it triggers an event or activates or deactivates a function of the hearing aid. This could be for instance a visual indication in the form of a corresponding warning light or a text message on an appropriate display screen. This signal could also be transmitted for instance to a service center, thus informing the latter of the event concerned and enabling it to prepare for the maintenance service or perhaps even to arrange for the necessary spare parts or replacement modules to be available.

It is further possible to provide for instance additional sensors for the acquisition or recognition of certain events or functional processes in the hearing aid, connected in each case to one or several meters. This could detect for instance processes that are not a direct function of, or detectable through, the configuration or circuitry of the hearing aid but are the result of actions by the user in the operation or manipulation of the hearing aid. For example, this may reveal how often the controls such as the volume control have been manipulated or how often the hearing aid has been put on or taken off. This purpose is served by special detectors connected to corresponding counters.

The sensors may be designed for instance in a way as to register as events or functional processes the number of times the power supply fell below a specific voltage level, feedback was detected, the level was exceeded, or the user inserted or removed the hearing aid.

For example, the meter may be implemented as a pure software-based counter in the signal processing unit. The meters or counters may be self-contained modules or they may be integrated and operated within the software of the signal processing unit.

Additionally provided, for example, is a non-volatile memory module or memory location in which the event and/or the time the threshold was exceeded is stored. This allows the service center, for instance when the repair or maintenance service of the hearing aid is indicated, to ascertain whether any thresholds, and how many, have been exceeded and to draw appropriate conclusions. This may reduce for instance the time spent on troubleshooting since in all likelihood it will substantially narrow down the range of possible causes of a problem.

The concept according to the invention makes it possible to extend the life of the hearing aid owing to use-related maintenance, and to shorten the maintenance process which in turn reduces the cost of maintenance. At the same time it improves the quality of the maintenance and upkeep since that can be performed in more targeted fashion.

It will be obvious to those skilled in the art that this invention is not limited to hearing aids as described above, serving to compensate or correct for impaired hearing. Indeed, the invention can be employed with any auxiliary hearing devices serving to improve communication.

The objective of the invention is further achieved with the conceptual features of the method specified in claim 11. Other possible implementation versions are characterized by the features described in claims 12 to 18.

According to the invention, the method for operating a hearing aid that incorporates at least one signal processing unit, at least one meter for measuring discrete events or functional processes and at least one memory module for storing the respective meter count, status and assigned threshold values, provides
for each operating-status change of interest to be identified by a measurable event or functional process;
for each measurable event or functional process to be associated with at least one meter;
for each meter to be assigned a threshold value;
for a signaling device to be activated when the threshold of a meter is exceeded;
for the signaling device to generate a predefined signal as a correlative function of the threshold concerned.

This permits a response to any hearing-aid-related event or functional process, in that the attainment of the respectively associated threshold is automatically brought to the user's attention without requiring manual ascertainment or monitoring by him. As a rule, the events concerned are not of the periodically recurrent, clocked type but are aperiodic, random events or potential events.

For example, the signaling device generates an acoustic signal and/or a visual signal and/or a wireless signal and/or a mechanical signal. An acoustic signal could be a simple sound or a spoken voice message. A visual signal could be the activation of a lamp or the display of a message on a monitor screen. A wireless signal could be the transmission of an electrical signal via radio waves or Bluetooth. A mechanical signal could be the activation of a vibrator serving as a mechanical signal as known for instance in cell phone technology.

As an example, a timer is automatically reset after a certain time has elapsed. The reset function could be periodic, taking place after a certain period has elapsed. This type of meter captures and, where applicable, displays especially events that are repeated at short time intervals.

For example, the activation signal for the signaling device may be separately stored in a non-volatile memory, i.e. at least the basic activation as such plus perhaps the time of the activation. It is thus possible at a later time to determine what activations have taken place, and when. That evaluation can give especially a service center valuable and time-saving information relative to the operating pattern of the hearing aid and/or the operational control pattern of the user. Information of that nature can more easily and quickly pinpoint a possible problem and permit appropriate corrective action.

Examples of events or functional processes include the following:
on/off switching; and/or
frequency of battery replacement; and/or
actuation of mechanical and/or electrical functions of the hearing aid; and/or
reaching a specific date; and/or
number of times the hearing aid has been placed in or on the ear.

Keeping track of these events, which have a significant bearing on the quality of the hearing aid and may be a key factor in determining the necessary servicing intervals for devices of this type, has so far had to be done manually by the user himself, or it simply was not done at all. That makes it necessary to set servicing intervals strictly along a fixed schedule, which does not in any way reflect reality. To assure high quality, the time intervals are usually too short, unnecessarily increasing the cost, or for cost considerations they are spaced too far apart which in some cases can lead to qualitative deterioration. The solution presented by this invention does not have these drawbacks; instead, it permits a cost-effective, individualized approach.

For example, the signaling device generates the signal either immediately, or after a certain time has elapsed, or the next time the unit is switched on, or at a preset time thereafter. This allows for a suitably timed response to the event that triggers the signal.

The signal generated by the signaling device is transmitted for instance to a service center. For example, the signal may be radioed wirelessly to a communication point from where it is routed to a service center. This can alert the service center to a possibly impending service requirement, enabling it to prepare for, and then perform, any necessary work.

For example, the signaling device could generate the signal once or twice, i.e. the signal is generated and displayed either as a simple one-time signal, or as a multiple signal sequentially generated and displayed at specific time intervals. The user could for instance interrupt the repetitive signal or turn it off entirely, as for instance in the case of an electric alarm clock.

The following will explain this invention in more detail with the aid of the attached drawings in which:

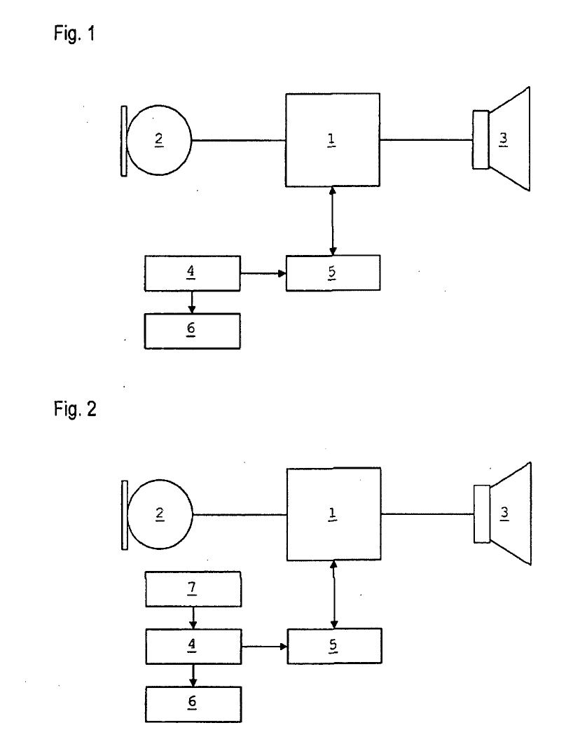

FIG. 1 is a schematic illustration of the hearing aid according to the invention;

FIG. 2 is a schematic illustration as in FIG. 1, with the addition of a sensor serving to detect certain events or functional processes.

FIG. 1 schematically illustrates a hearing aid according to this invention. A signal processing unit 1 connects to a microphone 2 and a speaker 3. The sound received via the microphone 2 is processed by the signal processing unit 1 and ultimately played back through the speaker 3. This illustration is purely schematic and highly simplified, representing the basic process of the reception and playback of audio signals in hearing aids.

The signal processing units 1 used nowadays are often in the form of electronic modules that can be adapted to the individual requirements of the user of the hearing aid, thus permitting optimized utility. In many cases, hearing aids of this type are used not only to compensate or correct for the user's hearing impairment but also to improve or support audio communication.

Also provided is at least one meter 4 that connects to the signal processing unit 1. The meter 4 may for instance be designed as a separate electronic module, or perhaps in the form of a software-based meter or pure software logic in a programmable module.

Using the meter 4 permits the acquisition of any quantifiable events or processes in and around the hearing aid and a comparison of the meter reading with an associated threshold value. These threshold values, individually defined, can be advantageously stored in a non-volatile memory module 6 of the hearing aid.

A permanent identification of the attainment or overrun of the threshold of a meter 4 can be advantageously accomplished by storing the event concerned in the non-volatile memory 6 of the hearing aid, possibly also including for instance the time at which the threshold was exceeded. The audiologist or the service center can subsequently retrieve these data simply by reading out the corresponding memory location of the memory module 6 and on that basis take whatever action may be needed.

The hearing aid according to this invention thus enables the audiologist and perhaps the service center to perform focused maintenance of the hearing aid and to detect a possibly concealed defect or improper handling of the hearing aid by the user.

When the threshold is reached or exceeded, the meter 4 will also activate a signaling device 5 which functionally interacts with the signal processing unit 1.

It will be obvious to those skilled in the art that the components illustrated in FIG. 1, such as the meter 4, the signaling device 5 and the memory module 6, may be directly integrated into the signal processing unit 1, and also that several meters 4 can be used in parallel or independently from one another.

FIG. 2 shows the device schematically illustrated in FIG. 1, with the addition of a sensor 7. The configuration of that sensor 7 will differ depending on the event to be acquired, and several sensors 7 may be associated with one meter 4, or one sensor 7 can feed its input [sic] into several meters 4, i.e. it may be connected to several meters 4.

The following will outline a few possible implementation examples of a hearing aid according to the invention, as well as the related operating method.

In the case of a digital hearing aid where the microphone cover is situated on the outside of the enclosure, the signaling device can alert the user to changes in the microphone cover. Such soiling is primarily due to dirty fingers and sweaty palms to which the hearing aid is exposed when being turned on or off. Since the on/off button is located directly next to the microphone cover, the number of on/off switching operations correlates linearly with the degree of potential soiling of the microphone cover. For that reason the meter of the hearing aid is coupled to the on/off signal. The number of these operations is compared with a predefined threshold value which, when exceeded, will trigger for instance an acoustic signal alerting the user to he need to replace the microphone cover or to have it replaced.

The meter is advantageously provided with a delay circuit that will suppress a rapid, virtually immediate succession of on/of operations and will register them as only a single event, given that events of that nature have essentially no influence on the soiling of the microphone cover. The delay circuit can produce a delay time for instance of 30 minutes, or of a significantly shorter time span of just a few minutes or even seconds.

The acoustic signal is triggered for instance immediately upon the occurrence of the event, or with a time delay of for instance 30 seconds after the event, or not until the next triggering event takes place. That could be a particular time span such as 30 seconds after the next switch-on operation. Since the event is stored in memory, the service center can determine whether the acoustic signal was in fact followed by a replacement action, by optically examining the microphone cover. Based on that information the threshold value can be modified if necessary, i.e. raised or lowered for the individual user concerned.

As an example in the case of a digital hearing aid equipped with a programming button, the pressing of that programming button may be registered as an event associated with a meter and a threshold value. Since for the manual switching of the auditory program of the hearing aid the programming button as well is located directly next to the microphone cover, the frequency of program changes as well will correlate with the degree of soiling of the microphone cover. It would be possible for example to combine the two meters, i.e. to add up their counts to a joint threshold value as a reminder to replace the microphone cover.

For instance in a first approximation the number of on/off switching operations can be equated to how often the hearing aid is inserted in the ear. This makes it possible, for instance after a corresponding threshold value is exceeded, to generate an audio message, or acoustic signal, as a reminder to replace the cerumen shield.

For example, when using a digital hearing aid the user may be reminded to visit the acoustician and have new ear adapters made when the number of feedback suppression operations has exceeded a certain threshold. A counter of that type may be reset automatically after a certain period has expired, so as to allow the determination of the frequency of occurrences within a short time span rather than in terms of absolute numbers. Alternatively, it may point out to the user that the hearing aid is not correctly positioned in the ear canal.

In addition, it is possible for instance to define and set a threshold for the cumulative actuation of the programming button and volume control, which may indicate the need to adjust the auditory program or the hearing aid. In that case it clearly suggests to the wearer of the hearing aid, via the signaling device, that he pay a visit to the acoustician.

1. A hearing aid incorporating at least one signal processing unit (1), at least one meter (4) for counting discrete events or functional processes, and at least one memory module (6) for storing the respective meter count and status information as well as the threshold values assigned to each meter (4), characterized in that, in addition, a signaling device (5) is provided that is functionally connected with the signal processing unit (1) in a manner whereby, when the threshold value of a meter (4) is reached or exceeded, the signaling device (5) is activated.

2. The hearing aid of claim 1, characterized in that the signaling device (5) is integrated into the signal processing unit (1).

3. The hearing aid of claim 1, characterized in that the signaling device (5) generates an acoustic signal.

4. The hearing aid of claim 3, characterized in that the acoustic signal is generated as a simple sound, a tune or a voice message.

5. The hearing aid of claim 1, characterized in that the signaling device (5) generates a visual signal.

6. The hearing aid of claim 1, characterized in that it is additionally provided with a wireless transmitter that is functionally connected with the signaling device (5) and the signal processing unit (1) in a manner whereby, when the threshold value of a meter (4) is reached or exceeded, a wireless signal is generated.

7. The hearing aid of claim 1, characterized in that it is additionally provided with sensors (7) that serve to detect and recognize certain events or functional processes of the hearing aid and are each connected to one or several meters (4).

8. The hearing aid of claim 7, characterized in that the sensors (7) are so configured that they identify or detect as events or functional processes the number of shortfalls of a defined voltage level of the power source, the number of feedbacks registered, the number of level overruns, and the number of times the user inserts and removes the hearing aid.

9. The hearing aid of claim 1, characterized in that the meter (4) is designed as a pure software counter in the signal processing unit (1).

10. The hearing aid of claim 1, characterized in that the hearing aid is additionally provided with a non-volatile memory module or memory location in which the event and/or the time of a threshold overrun is stored.

11. A method for operating a hearing aid that incorporates at least one signal processing unit (1), at least one meter (4) for measuring discrete processes, and at least one memory module (6) for storing the respective meter count and status information as well as the threshold values assigned to each meter (4), characterized in that
a measurable event or functional process is allocated to each operating status change;
each measurable event or functional process is allocated to at least one meter (4);
at least one threshold value is assigned to each meter (4);
a signaling device (5) is activated when a threshold value of a meter (4) is exceeded;
the signaling device (5) generates a predefined signal as a function of the threshold value concerned.

12. The method of claim 11, characterized in that the signaling device (5) generates at least one of an acoustic signal, a visual signal, a wireless signal, or a mechanical signal.

13. The method of claim 11, characterized in that a meter (4) is automatically reset after a definable length of time has expired.

14. The method of claim 11, characterized in that the activation of the signaling device (5) is stored in a non-volatile memory location as a separate event consisting at least of the activation itself and, in addition, for instance of the time of the activation.

15. The method of claim 11, characterized in that the definition of events or functional processes includes at least one of:
on/off switching operations;
number of battery replacements;
actuation of mechanical or electrical functions of the hearing aid;
reaching a certain date; or
number of times the hearing aid is placed in or on the ear.

16. The method of claim 11, characterized in that the signaling device (5) generates the signal immediately, or after a specific length of time has expired, or upon the next switch-on operation or upon expiration of a specific length of time thereafter.

17. The method of claim 11, characterized in that the signal generated by the signaling device (5) is transmitted to a service center.

18. The method of claim 11, characterized in that the signaling device (5) generates the signal once or several times.
